(19) United States
(12) Patent Application Publication
(10) Pub. No.: US 2011/0069514 A1
(43) Pub. Date: Mar. 24, 2011

(54) DC CONVERSION APPARATUS

(75) Inventor: Akiteru CHIBA, Niiza-shi (JP)

(73) Assignee: Sanken Electric Co., Ltd., Niiza-shi (JP)

(21) Appl. No.: 12/875,660

(22) Filed: Sep. 3, 2010

(30) Foreign Application Priority Data
Sep. 24, 2009 (JP) 2009-219079

(51) Int. Cl. H02M 3/335

(52) U.S. Cl. 363/21.02

(57) ABSTRACT

A DC conversion apparatus includes a plurality of current resonant converters. Each of the current resonant converters has two switching elements connected in series, a transformer having primary and secondary windings, a series resonant circuit including a resonant reactor, the primary winding of the transformer, and a resonant capacitor, and a rectifying circuit to rectify a voltage generated by the secondary winding of the transformer. The DC conversion apparatus also includes a smoothing circuit having a reactor L3 and a smoothing capacitor C and arranged after connection points to which output terminals of the rectifying circuits of the plurality of current resonant converters are commonly connected. The DC conversion apparatus further includes a controller to control, according to an output voltage from the smoothing circuit, ON/OFF of the two switching elements of each of the plurality of current resonant converters.

### BACKGROUND OF THE INVENTION

1. Field of the Invention

The present invention relates to a DC conversion apparatus having a plurality of current resonant converters that are controlled to have a phase difference.

2. Description of the Related Art

DC conversion apparatuses with current resonant converters have been used as high-efficiency, low-noise power source apparatuses. Generally, the DC conversion apparatus switches power from a DC power source into a switching output through a switching circuit, supplies the switching output to a resonant circuit, provides a resonant output from windings of a transformer in the resonant circuit, and converts the resonant output into a DC output. When large output power is needed, the DC conversion apparatus must be designed in consideration of an increase in the temperature of the transformer and other parts. This results in enlarging the size of the apparatus and increasing the cost thereof.

To provide large output power without enlarging the size or increasing the cost, there is a known technique of connecting a plurality of current resonant converters in parallel. FIG. 1 is a circuit diagram illustrating a DC conversion apparatus according to such a related art. In FIG. 1, the DC conversion apparatus employs two current resonant converters connected in parallel. The first current resonant converter has switching elements Q11 and Q12, a resonant reactor L1, a transformer T1, a resonant capacitor C1, diodes D11 and D12, and a smoothing capacitor C. The second current resonant converter has switching elements Q21 and Q22, a resonant reactor L2, a transformer T2, a resonant capacitor C2, diodes D21 and D22, and the smoothing capacitor C.

Both ends of a DC power source Vin are connected to a series circuit including the switching elements Q11 and Q12 that are MOSFETs. In parallel with this series circuit, a series circuit of the switching elements Q21 and Q22 that are MOSFETs is connected. Drains of the switching elements Q11 and Q21 are connected to a positive electrode of the DC power source Vin. Sources of the switching elements Q12 and Q22 are connected to a negative electrode of the DC power source Vin.

The resonant reactor L1, a primary winding P1 of the transformer T1, and the resonant capacitor C1 form a series resonant circuit that is connected between the drain and source of the switching element Q12. The resonant reactor L2, a primary winding P2 of the transformer T2, and the resonant capacitor C2 form a series resonant circuit that is connected between the drain and source of the switching element Q22.

The transformer T1 has the primary winding P1 and secondary windings S11 and S12. A first end of the secondary winding S11 is connected to an anode of the diode D11. A second end of the secondary winding S11 and a first end of the secondary winding S12 are connected to a first end of the smoothing capacitor C. A second end of the secondary winding S12 is connected to an anode of the diode D12. Cathodes of the diodes D11 and D12 are connected to a second end of the smoothing capacitor C.

The transformer T2 has the primary winding P2 and secondary windings S21 and S22. A first end of the secondary winding S21 is connected to an anode of the diode D21. A second end of the secondary winding S21 and a first end of the secondary winding S22 are connected to the first end of the smoothing capacitor C. A second end of the secondary winding S22 is connected to an anode of the diode D22. Cathodes of the diodes D21 and D22 are connected to the second end of the smoothing capacitor C.

A controller 1 uses an output voltage Vout from the smoothing capacitor C, to output control signals to gates of the switching elements Q11, Q12, Q21, and Q22 and control the output voltage Vout of the smoothing capacitor C to a constant value.

Under the control of the controller 1, the series-connected switching elements Q11 and Q12 alternately turn on to switch power from the DC power source Vin into a switching output and supply the switching output to the series resonant circuit including the primary winding P1 of the transformer T1.

The series resonant circuit including the resonant reactor L1, primary winding P1, and resonant capacitor C1 passes a sinusoidal current corresponding to a switching frequency of the switching elements Q11 and Q12. At this time, the secondary windings S11 and S12 magnetically coupled with the primary winding P1 induce voltages, which are converted into a direct current by the diodes D11 and D12 connected to the secondary windings S11 and S12 and the smoothing capacitor C.

Under the control of the control circuit 1, the series-connected switching elements Q21 and Q22 alternately turn on to switch power from the DC power source Vin into a switching output and supply the switching output to the series resonant circuit including the primary winding P2 of the transformer T2.

A sinusoidal current corresponding to a switching frequency of the switching elements Q21 and Q22 passes through the series resonant circuit including the resonant reactor L2, primary winding P2, and resonant capacitor C2. At this time, the secondary windings S21 and S22 magnetically coupled with the primary winding P2 induce voltages, which are converted into a direct current by the diodes D21 and D22 connected to the secondary windings S21 and S22 and the smoothing capacitor C.

Operation of the DC conversion apparatus of FIG. 1 will briefly be explained. The controller 1 turns on the switching element Q11, to pass a current clockwise on the primary side of the transformer T1 through a path extending along Vin, Q11, L1, P1, C1, and Vin, thereby charging the resonant capacitor C1. At this time, a voltage induced on the secondary side of the transformer T1 is provided from the secondary winding S11, is rectified and smoothed with the diode D11 and smoothing capacitor C, and is provided as the output Vout to a load.

The controller 1 turns off the switching element Q11 and on the switching element Q12, to discharge the resonant capacitor C1 through the primary winding P1. At this time, a current passes through the primary winding P1 in an opposite direction to that of charging the resonant capacitor C1 and induces a voltage on the secondary side of the transformer T1. The voltage induced on the secondary side of the transformer T1 is provided from the secondary winding S12, is rectified and smoothed with the diode D12 and smoothing capacitor C, and is provided as the output Vout to the load.

The controller 1 changes an ON period of the switching elements Q11 and Q12, i.e., a charge/discharge period of the resonant capacitor C1, thereby controlling an amount of power induced on the secondary side of the transformer T1.

In this way, the controller 1 controls the switching elements Q11 and Q12 and operates the first current resonant converter. The controller 1 also controls the switching elements Q21 and Q22, to operate the second current resonant converter having a phase difference of 90 degrees with respect to the first current resonant converter. The DC conversion apparatus of FIG. 1 operates the current resonant converters in parallel, to provide large output power.

Japanese Unexamined Patent Application Publication No. 2005-33956 (Patent Document 1) discloses a power source apparatus that operates two or more current resonant switching converters in parallel and balances currents to equalize output power borne by the converters. This power source apparatus includes first and second field effect transistors (FETs) connected to a drive circuit arranged on a primary winding side of a transformer, a source of the first FET being connected to a drain of the second FET, a capacitor arranged between a source of the second FET and a first end of the primary winding of the transformer, and a smoothing circuit arranged on a secondary winding side of the transformer, to form a resonant converter block. At least two resonant converter blocks are arranged in parallel and choke coils that form the smoothing circuits are magnetically coupled with each other.

This power source apparatus has a simple circuit configuration to operate the two or more current resonant switching converters in parallel and provide large output power without increasing the size and cost of the apparatus.

This power source apparatus magnetically couples the choke coils arranged on the secondary side of the resonant converter transformers, to correct an inductance and optimize resonant conditions of the parallel operation of the two or more current resonant switching converters. Consequently, the power source apparatus is capable of adjusting the phase and amplitude of currents, balancing the currents, equalizing the temperatures of parts used in the apparatus, averaging output power from the current resonant switching converters operated in parallel, and equalizing the service life of the parts.

### SUMMARY OF THE INVENTION

The DC conversion apparatus with a plurality of current resonant converters according to the related art stabilizes the output of each current resonant converter by controlling a switching frequency and changing the impedance of the series resonant circuit. Generally, circuit constant values of the resonant capacitor and resonant reactor that form each series resonant circuit slightly differ among the current resonant converters. It is very difficult, therefore, to equalize currents borne by the current resonant converters. If the currents are imbalanced, i.e., if the current resonant converters provide different current values, the efficiency of the apparatus will deteriorate and the transformers and switching elements will generate heat and break.

For example, if the resonant reactors L1 and L2 in the DC conversion apparatus of the related art illustrated in FIG. 1 have the same inductance and if the resonant capacitors C1 and C2 have the same capacitance, the series resonant circuits in the current resonant converters will have the same impedance. Then, it will relatively be easy to equalize currents borne by the current resonant converters. Equalizing the impedances of the series resonant circuits with each other based on the characteristics of parts, however, needs the measurement and selection of the resonant reactors and resonant capacitors in connection with their circuit constants. This involves a large cost.

FIG. 2 is a waveform diagram illustrating currents passing to the resonant capacitors C1 and C2 in the DC conversion apparatus of the related art of FIG. 1 with the series resonant circuits of the current resonant converters involving a constant difference between them. In FIG. 2, the constant difference such as L1≠L2, or C1≠C2 causes a difference in resonant conditions between the series resonant circuits of the current resonant converters. As a result, a current peak value of the resonant capacitor C1 greatly differs from that of the resonant capacitor C2.

The power source apparatus of the Patent Document 1 magnetically couples the choke coils arranged on the secondary winding side of each resonant converter transformer, to correct an inductance and balance currents. This power source apparatus, however, needs the magnetic circuits whose number is dependent on the number of units to be operated in parallel. Namely, this related art has a problem of increasing cost and circuit size as the number of units to be operated in parallel increases.

To solve the problems of the related arts mentioned above, the present invention provides a DC conversion apparatus that is manufacturable at low cost, has a simple configuration, and is capable of properly balancing currents passing through a plurality of current resonant converters that are operated at a predetermined phase difference.

According to an aspect of the present invention, the DC conversion apparatus includes (i) a plurality of current resonant converters each including two switching elements connected in series, a transformer having a primary winding and a secondary winding, a series resonant circuit including a resonant reactor, the primary winding of the transformer, and a resonant capacitor, and a rectifying circuit configured to rectify a voltage generated by the secondary winding of the transformer, (ii) a smoothing circuit including a reactor and a smoothing capacitor and arranged after connection points to which output terminals of the rectifying circuits of the plurality of current resonant converters are commonly connected, and (iii) a controller configured to control, according to an output voltage from the smoothing circuit, ON/OFF of the two switching elements of each of the plurality of current resonant converters.

### BRIEF DESCRIPTION OF THE DRAWINGS

FIG. 1 is a circuit diagram illustrating a DC conversion apparatus according to a related art;

FIG. 2 is a waveform diagram illustrating currents passing through resonant capacitors in current resonant converters of the DC conversion apparatus of FIG. 1 with the current resonant converters involving a deviation among their circuit constants;

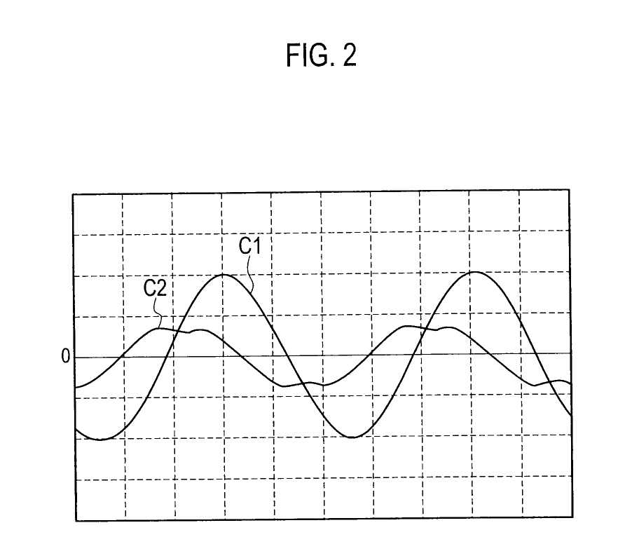

FIG. 3 is a circuit diagram illustrating a DC conversion apparatus according to Embodiment 1 of the present invention;

FIG. 4 is a diagram illustrating waveforms sent from a controller to gates of switching elements in the DC conversion apparatus of Embodiment 1;

FIG. 5 is a waveform diagram illustrating currents passing through resonant capacitors and a ripple current passing through a reactor on the secondary side in the DC conversion apparatus of Embodiment 1; and

FIG. 6 is a circuit diagram illustrating a DC conversion apparatus according to a modification of Embodiment 1.

### DESCRIPTION OF THE PREFERRED EMBODIMENT

A DC conversion apparatus according to an embodiment of the present invention will be explained in detail with reference to the drawings.

### Embodiment 1

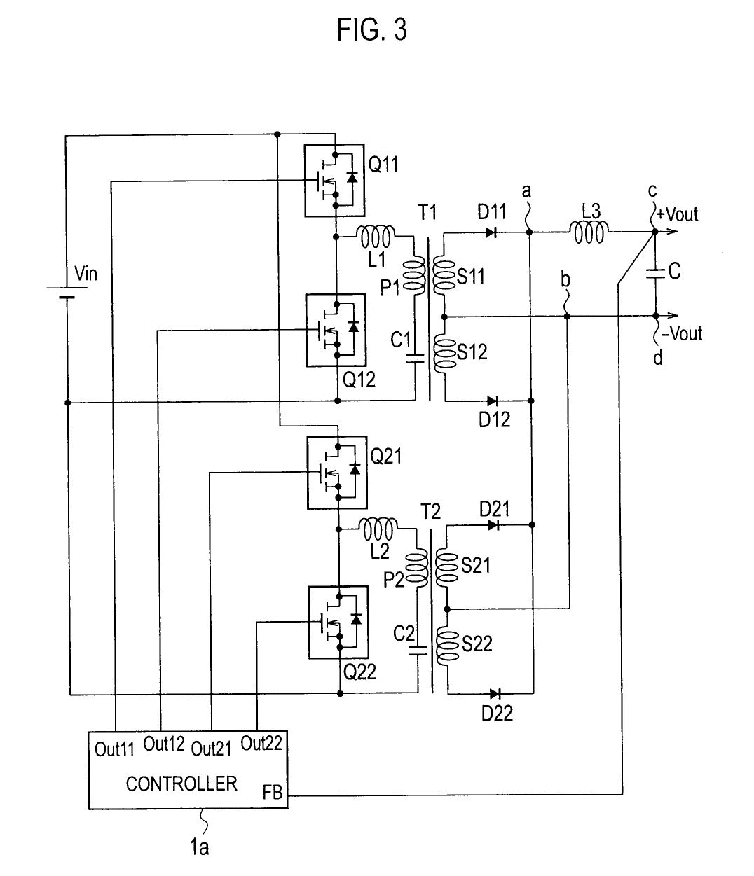

FIG. 3 is a circuit diagram illustrating a DC conversion apparatus according to Embodiment 1 of the present invention. The DC conversion apparatus has two current resonant converters, a smoothing circuit, and a controller 1a. Although the number of the current resonant converters arranged in the DC conversion apparatus of Embodiment 1 is two, this does not limit the present invention. The DC conversion apparatus according to the present invention may employ any number of current resonant converters.

The two current resonant converters in the DC conversion apparatus illustrated in FIG. 3 have the same circuit configuration. Namely, each of the current resonant converters has two switching elements connected in series, a transformer having primary and secondary windings, a series resonant circuit including a resonant reactor, the primary winding of the transformer, and a resonant capacitor, and a rectifying circuit to rectify a voltage generated by the secondary winding of the transformer.

In FIG. 3, the first current resonant converter has the two switching elements Q11 and Q12 connected in series, the transformer T1 having the primary winding P1 and secondary windings S11 and S12, the series resonant circuit including the resonant reactor L1, primary winding P1, and resonant capacitor C1, and the rectifying circuit including diodes D11 and D12 to rectify voltages generated by the secondary windings S11 and S12.

The secondary windings S11 and S12 of the transformer T1 are connected in series in phase. Voltages generated by the secondary windings S11 and S12 are rectified with the diodes D11 and D12 and are smoothed with a reactor L3 and a smoothing capacitor C, to provide an output voltage Vout.

The second current resonant converter has the two switching elements Q21 and Q22 connected in series, the transformer T2 having the primary winding P2 and secondary windings S21 and S22, the series resonant circuit including the resonant reactor L2, primary winding P2, and resonant capacitor C2, and the rectifying circuit including diodes D21 and D22 to rectify voltages generated by the secondary windings S21 and S22.

The secondary windings S21 and S22 of the transformer T2 are connected in series in phase. Voltages generated by the secondary windings S21 and S22 are rectified with the diodes D21 and D22 and are smoothed with the reactor L3 and smoothing capacitor C, to provide the output voltage Vout.

In each of the transformers T1 and T2, a voltage on the output side is lower than a voltage on the input side. Namely, in the transformer T1, the number of turns of the secondary winding S11 (S12) is smaller than that of the primary winding P1, to carry out a step-down operation. In the transformer T2, the number of turns of the secondary winding S21 (S22) is smaller than that of the primary winding P2, to carry out a step-down operation. The transformers T1 and T2 have the same turn ratio.

The series circuit of the switching elements Q11 and Q12 is connected to both ends of a DC power source Vin. The series circuit of the switching elements Q21 and Q22 is also connected to the ends of the DC power source Vin. The switching elements Q11, Q12, Q21, Q22 are, for example, MOSFETs. Drains of the switching elements Q11 and Q21 are connected to a positive electrode of the DC power source Vin. Sources of the switching elements Q12 and Q22 are connected to a negative electrode of the DC power source Vin.

The series resonant circuit of the resonant reactor L1, primary winding P1, and resonant capacitor C1 is connected between the drain and source of the switching element Q12. The series resonant circuit of the resonant reactor L2, primary winding P2, and resonant capacitor C2 is connected between the drain and source of the switching element Q22.

The smoothing circuit of the DC conversion apparatus according to the present invention is arranged after connection points (a, b) to which output ends of the rectifying circuits of the current resonant converters are commonly connected. The smoothing circuit includes the reactor and smoothing capacitor. Namely, the smoothing circuit is arranged after the connection points as depicted by “a” and “b” to which the output ends of the rectifying circuits of the two current resonant converters are commonly connected. The smoothing circuit includes the reactor L3 and smoothing capacitor C. The output voltage Vout of the smoothing circuit is provided from ends depicted by “c” and “d” of the smoothing capacitor C.

The controller 1a controls, based on the voltage Vout from the smoothing circuit, ON/OFF of the two switching elements of each current resonant converter, i.e., the switching elements Q11 and Q12 of the first current resonant converter and the switching elements Q21 and Q22 of the second current resonant converter.

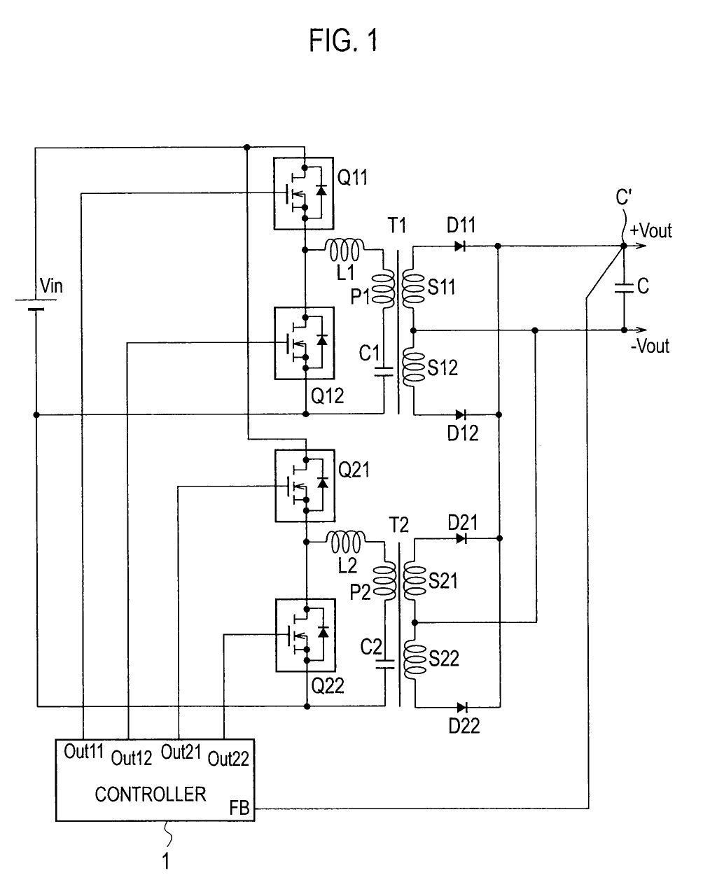

Compared with the DC conversion apparatus of the related art illustrated in FIG. 1, Embodiment 1 of FIG. 3 is characterized in that Embodiment 1 additionally has the reactor L3.

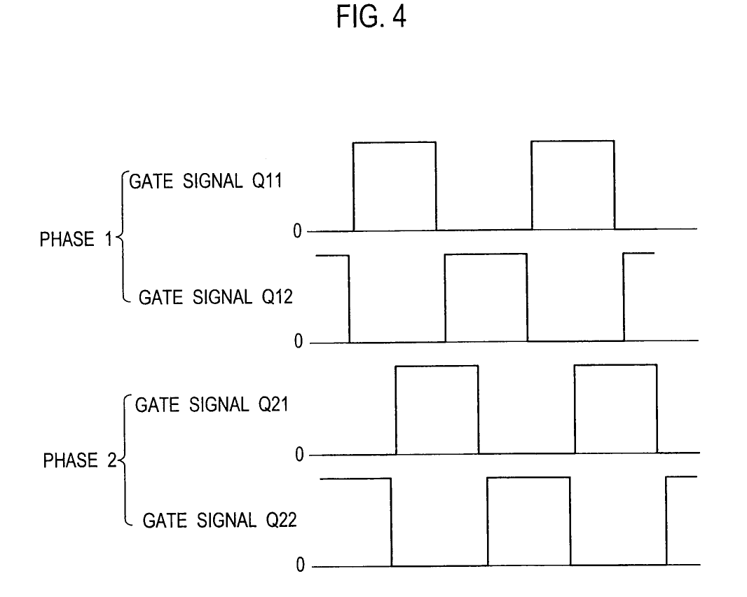

Operation of Embodiment 1 will be explained. FIG. 4 is a diagram illustrating waveforms applied from the controller 1a to gates of the switching elements Q11, Q12, Q21, and Q22 in the DC conversion apparatus of Embodiment 1. As illustrated in FIG. 4, the controller 1a carries out multiphase control to establish a phase difference of 90 degrees between the two current resonant converters.

If the number of the current resonant converters is increased, the phase difference is adjusted according to the number of the current resonant converters connected in parallel, i.e., the number of phases. Namely, the controller 1a controls ON/OFF of the two switching elements contained in each current resonant converter so that a phase difference of π/n (n is the number of the current resonant converters) is given among the phases of sinusoidal currents passing through the primary windings of the transformers in the current resonant converters. In the case of two phases like Embodiment 1, the controller 1a provides a phase difference of 90 degrees between the two current resonant converters. In the case of three phases, the controller 1a provides a phase difference of 60 degrees among three current resonant converters, and in the case of four phases, a phase difference of 45 degrees among four current resonant converters.

Operation of the controller 1a according to Embodiment 1 will be explained. The controller 1a controls the switching elements Q11 and Q12 so that they alternately turn on/off with the same ON width as illustrated in FIG. 4, to pass a sinusoidal current corresponding to a switching frequency through the series resonant circuit of the resonant reactor L1, primary winding P1, and resonant capacitor C1.

Also, the controller 1a controls the switching elements Q21 and Q22 so that they alternately turn on/off with the same ON period at a phase difference of 90 degrees with respect to the first current resonant converter, to pass a sinusoidal current corresponding to a switching frequency through the series resonant circuit of the resonant reactor L2, primary winding P2, and resonant capacitor C2.

A resonant time constant of the series resonant circuit of the resonant reactor L1, primary winding P1, and resonant capacitor C1 is equalized with that of the series resonant circuit of the resonant reactor L2, primary winding P2, and resonant capacitor C2, so that the sinusoidal current passing through the series resonant circuit including the resonant capacitor C2 has a phase difference of 90 degrees with respect to the sinusoidal current passing through the series resonant circuit including the resonant capacitor C1.

The reactor L3 arranged on the secondary side contributes to adjust resonant conditions between the two series resonant circuits. According to Embodiment 1, the transformers T1 and T2 have the same turn ratio and the number of turns on the primary side is larger than that on the secondary side. Accordingly, an apparent impedance observed from the primary side becomes larger than an actual impedance of the reactor L3 on the secondary side and is equal to a square of the turn ratio (the ratio of the number of turns on the primary side to the number of turns on the secondary side).

Even if circuit constant values related to the resonant capacitors and resonant reactors slightly differ between the two current resonant converters, the inductance of the reactor L3 largely influences on the primary side, to adjust resonant conditions of the series resonant circuits so that the circuit constant difference causes no imbalance in currents.

As mentioned above, the reactor L3 is arranged after the connection points “a” and “b” to which the output ends of the rectifying circuits of the current resonant converters are commonly connected. Accordingly, the reactor L3 evenly acts on each current resonant converter, to adjust, on the secondary side, resonant conditions.

An output voltage of the transformer becomes lower as the turn ratio of the transformer becomes larger, and as the turn ratio becomes larger, a resonant inductance that is usually set on the primary side makes an output impedance on the secondary side smaller. This means that the inductance of the reactor L3 used to adjust resonant conditions on the secondary side is allowed to be small, such as 1 μH or lower.

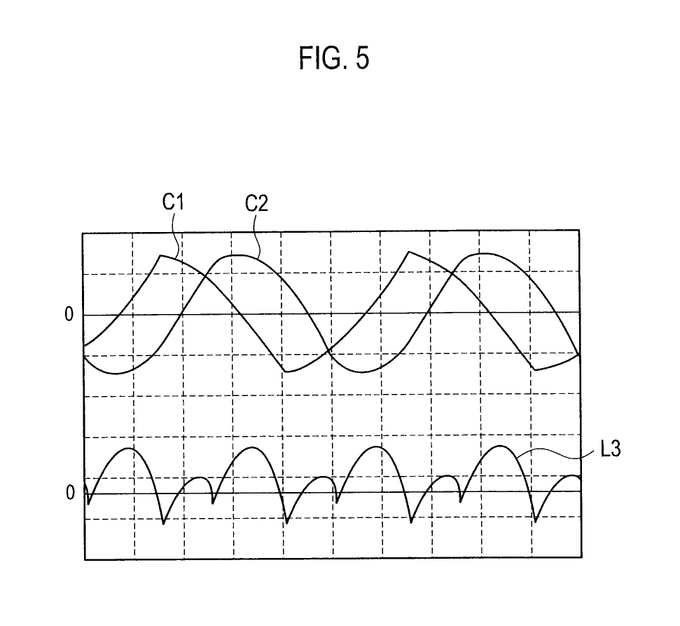

FIG. 5 is a waveform diagram illustrating currents passing through the resonant capacitors C1 and C2 and a ripple current passing through the reactor L3 on the secondary side in the DC conversion apparatus of Embodiment 1. The current waveforms (2 A/div) of FIG. 5 are obtained when an input voltage from the DC power source Vin is 400 V and output power is 12V and 40 A. The reactor L3 adjusts resonant conditions of the series resonant circuits in the current resonant converters and properly balances currents so that the currents passing through the resonant capacitors C1 and C2 have a phase difference of 90 degrees and substantially the same peak value as illustrated in FIG. 5.

The sinusoidal current passing through the primary winding P1 of the transformer T1 produces voltages on the secondary windings S11 and S12 of the transformer T1. These voltages are rectified with the rectifying circuit (diodes D11 and D12). Similarly, the sinusoidal current through the primary winding P2 of the transformer T2 produces voltages on the secondary windings S21 and S22 of the transformer T2. These voltages are rectified with the rectifying circuit (diodes D21 and D22).

The rectified currents pass through the reactor L3. Namely, the currents from the two current resonant converters have a phase difference of 90 degrees and are full-wave-rectified so that, when they join together at the reactor L3, they complement each other to reduce a ripple current. The ripple current illustrated in FIG. 5 passing through the reactor L3 is 980 mArms with respect to the output of 40 A and is very small. The effect of the interleave operation to reduce the ripple current is demonstrated even when the number of the current resonant converters is increased such as three phases at a phase difference of 60 degrees, four phases at a phase difference of 45 degrees, and the like.

The smoothing capacitor C is usually an electrolytic capacitor having a specified allowable ripple current. To satisfy the specified value, several pieces of electrolytic capacitors are usually connected in parallel to form the smoothing capacitor C. The DC conversion apparatus of Embodiment 1 reduces the ripple current, and therefore, is capable of reducing the number of electrolytic capacitors that form the smoothing capacitor C, thereby reducing the cost and size of the apparatus. In addition, the apparatus of Embodiment 1 is capable of elongating the service life of the electrolytic capacitors.

The frequency of a current passing through the reactor L3 is twice as large as the frequency of a current from each current resonant converter. The reactor L3 of Embodiment 1 is arranged after the connection points to which the output ends of the rectifying circuits on the secondary side of the current resonant converters are commonly connected, and the current resonant converters have a phase difference. Due to these two points, the reactor L3 passes a current of high frequency. For example, in a case where the number of phases is two, the reactor L3 passes a current whose frequency is twice as large as that of a current passing through a reactor of a single phase or a reactor arranged in each phase. In a case where the number of phases is three, the reactor L3 passes a current whose frequency is triple as large as that of a current passing through a reactor of a single phase or a reactor arranged in each phase. Consequently, the apparatus of Embodiment 1 can be miniaturized and can have a low inductance value.

As mentioned above, the DC conversion apparatus according to Embodiment 1 has a simple configuration and is manufacturable at low cost. When operating the current resonant converters in parallel at a predetermined phase difference, the DC conversion apparatus of Embodiment 1 is capable of properly balancing currents passing through the current resonant converters.

Compared with the DC conversion apparatus of the related art illustrated in FIG. 1, the DC conversion apparatus of Embodiment 1 is characterized in that the reactor L3 is arranged after the connection points to which the output ends of the rectifying circuits arranged in the two current resonant converters are commonly connected, as illustrated in FIG. 3. This configuration is simple and manufacturable at low cost. The apparatus of Embodiment 1 is capable of adjusting resonant conditions of the series resonant circuits arranged on the primary side of the current resonant converters, to properly balance currents.

The DC conversion apparatus of Embodiment 1 needs no measurement nor selection of resonant reactors and resonant capacitors to adjust resonant conditions of the series resonant circuits, thereby further reducing the cost of the apparatus. The apparatus of Embodiment 1 properly balances currents passed through the current resonant converters, to prevent the transformers and switching elements from generating heat or being broken.

Unlike the power source apparatus of the Patent Document 1 that needs the same number of magnetic circuits as the number of units operated in parallel, to increase the cost and size of the apparatus as the number of units operated in parallel increases, the DC conversion apparatus of Embodiment 1 needs only one additional reactor without regard to the number of units operated in parallel (the number of parallel connections), thereby providing a remarkable effect in terms of cost and package size.

Embodiment 1 carries out an interleave operation on the current resonant converters at a phase difference of π/n where n is the number of the current resonant converters. In addition, Embodiment 1 arranges the reactor L3 after the common connection points of the output ends of the current resonant converters, to increase the frequency of a current passing through the reactor L3. This means that the inductance value of the reactor L3 is allowed to be low.

The interleave operation carried out by the DC conversion apparatus of Embodiment 1 has an effect of reducing a ripple current in the output of the apparatus. Due to this, the number of electrolytic capacitors used as the smoothing capacitor C can be reduced to decrease the cost and size of the apparatus and elongate the service life of the electrolytic capacitors.

The transformer in each current resonant converter of the DC conversion apparatus according to Embodiment 1 is of a step-down type with the number of turns of the secondary winding of the transformer being smaller than that of the primary winding thereof.

Accordingly, an apparent impedance observed from the primary side becomes larger than an actual impedance of the reactor L3 on the secondary side and is equal to a square of the turn ratio (the ratio of the number of turns on the primary side to the number of turns on the secondary side). Even with the small inductance value, the reactor L3 gives a large influence on the primary side, to adjust resonant conditions of the series resonant circuits and properly balance currents.

### Modification of Embodiment 1

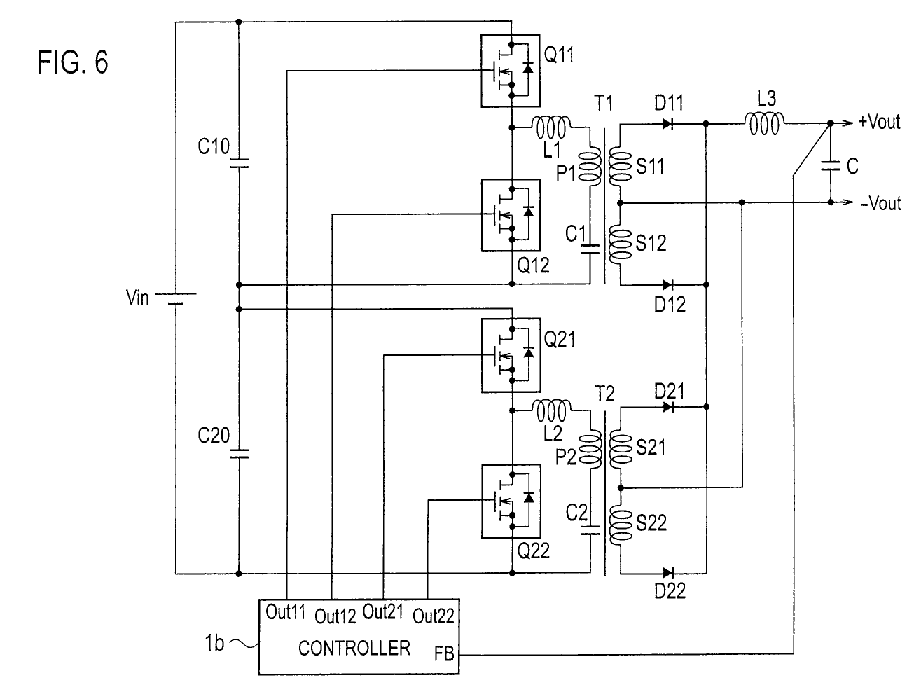

FIG. 6 is a circuit diagram illustrating a DC conversion apparatus according to a modification of Embodiment 1. The modification of FIG. 6 differs from Embodiment 1 of FIG. 3 in that the modification additionally has a voltage dividing circuit including voltage dividing capacitors C10 and C20.

The voltage dividing circuit has the same number of capacitors as the number of current resonant converters employed by the DC conversion apparatus. The two voltage dividing capacitors C10 and C20 are employed to the modification.

These capacitors are connected in series, to divide a source voltage from a DC power source Vin and supply DC power to each of the current resonant converters.

The voltage dividing capacitor C10 is connected in parallel with a series circuit of switching elements Q11 and Q12. The voltage dividing capacitor C20 is connected in parallel with a series circuit of switching elements Q21 and Q22.

The DC conversion apparatus of FIG. 6 differs from the DC conversion apparatus of FIG. 3 in the supply source of an input voltage to each current resonant converter and achieves the same operation and effect as the apparatus of FIG. 3. If parts such as the switching elements of the current resonant converters have a withstand voltage of 400 V and if the DC power source Vin provides an input voltage of 800 V, the modification has an advantage that the voltage dividing capacitors divide the input voltage for use by the parts. Namely, even if the input voltage is higher than the rated capacity of each part of the DC conversion apparatus, the modification of FIG. 6 can divide the input voltage for use by the parts. The DC conversion apparatus according to the modification is applicable without regard to the magnitude of an input voltage.

As mentioned above, the DC conversion apparatus according to the present invention has a simple configuration, is realizable at low cost, and is capable of balancing currents passing through current resonant converters that are operated in parallel at a given phase difference.

The DC conversion apparatus according to the present invention is usable as a DC conversion apparatus of a power source circuit in which a plurality of current resonant converters are connected in parallel.

This application claims benefit of priority under 35 USC §119 to Japanese Patent Application No. 2009-219079, filed on Sep. 24, 2009, the entire contents of which are incorporated by reference herein. Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. A DC conversion apparatus comprising:
a plurality of current resonant converters each including:
two switching elements connected in series;
a transformer having a primary winding and a secondary winding;
a series resonant circuit including a resonant reactor, the primary winding of the transformer, and a resonant capacitor; and
a rectifying circuit configured to rectify a voltage generated by the secondary winding of the transformer;
a smoothing circuit including a reactor and a smoothing capacitor and arranged after connection points to which output terminals of the rectifying circuits of the plurality of current resonant converters are commonly connected; and
a controller configured to control, according to an output voltage from the smoothing circuit, ON/OFF of the two switching elements of each of the plurality of current resonant converters.

2. The DC conversion apparatus of claim 1, wherein
the transformer carries out a step-down operation with the number of turns of the secondary winding being smaller than that of the primary winding.

3. The DC conversion apparatus of claim 1, wherein
the controller controls ON/OFF of the two switching elements of each of the current resonant converters in such a way as to cause a phase difference of it/n among the phases of sinusoidal currents passing through the primary windings of the transformers of the current resonant converters, where n is the number of the current resonant converters.

4. The DC conversion apparatus of claim 1, further comprising
a voltage dividing circuit connected to a DC power source and including series-connected capacitors whose number is the same as the number of the plurality of current resonant converters, wherein each of the series-connected capacitors is connected to both ends of the series-connected two switching elements of a corresponding one of the current resonant converters.
